(19) United States
(12) Patent Application Publication
(10) Pub. No.: US 2016/0356663 A1
(43) Pub. Date: Dec. 8, 2016

(54) FLUID PRESSURE MEASURING DEVICE

(71) Applicant: SC2N, Creteil Cedex (FR)

(72) Inventor: Olivier Dixneuf, Moult (FR)

(73) Assignee: SC2N, Creteil (FR)

(21) Appl. No.: 15/110,952

(22) PCT Filed: Jan. 7, 2015
(86) PCT No.: PCT/FR2015/050025

§ 371 Date: Aug. 23, 2016

(30) Foreign Application Priority Data
Jan. 12, 2014 (FR) 1450217

(51) Int. Cl. G01L 19/06; G01D 11/24

(52) U.S. Cl. CPC G01L 19/0627; G01D 11/245

(57) ABSTRACT

This invention relates to a device 1 for measuring the pressure of a fluid, containing iodized compounds, comprising a body 2 in which are arranged means enabling the pressure of the fluid to be measured, characterized in that it comprises means 5, 10 for protecting against the iodized compounds.

The invention also relates to a pressure sensor comprising means (5, 10) for protecting against the iodized compounds.

This invention relates to the field of devices for measuring the pressure of a fluid, and more particularly a sensor of the pressure of a fluid of a motor vehicle. The invention also relates to devices that enable the temperature and pressure of a fluid of a motor vehicle to be measured at the same time.

More precisely, the invention relates to a device for measuring the pressure, or pressure and temperature, of a fluid circulating in a pipe of an internal combustion engine of a motor vehicle.

Devices are already known that enable at least the pressure of a fluid of a motor vehicle to be measured.

These devices generally comprise a case, or a plate, in which are arranged a printed circuit and elements forming the sensor, namely the measuring cell of the sensor and the connecting wires that join the sensor to connections. Conventionally, the sensitive element of the sensor and the connecting wires are protected by a layer of gel. This sensor is mounted on the printed circuit. This assembly is protected by a resin injected into the product to protect all of the electrical parts and to seal the product.

Such devices are subject to the stresses of the medium in which they are arranged. More particularly, the air circulating in the pipes of internal combustion engines comprises iodized compounds such as iodine, diiodine or diiodomethane, which have a corrosive effect and can pass through the layer of gel. The damage to the layer of gel reduces the protection of the cell and the sensor connections, which are in their turn damaged by the presence of the iodized compounds and other elements present in the air in the pipes.

A temporary solution to the problem of damage to the layer of gel is to increase its thickness. However, after a certain time, whatever its thickness, the iodized compounds damage the layer of gel.

The aim of this invention is therefore to overcome one or more of the drawbacks of the devices of the prior art by proposing an improved device protected against the corrosive effects of the iodized compounds.

To this end, the present invention proposes a device for measuring the pressure of a fluid, containing iodized compounds, comprising a body in which are arranged means enabling the pressure of the fluid to be measured, the device comprising means for protecting against the iodized compounds.

According to an embodiment of the invention, the means of protection are made of aluminum.

According to an embodiment of the invention, the means of protection are made of or covered with zinc or tin or copper or silver or nickel.

According to a variation of the invention, the means of protection are incorporated into an air intake pipe of the device.

According to an embodiment of the invention, the means of protection are made so that their form matches the air intake pipe and allows contact with the fluid, while enabling the fluid to reach a sensor of the device.

According to an embodiment of the invention, the means of protection are formed by an additional element in the form of a portion of tube or a plate.

According to a variation of the invention, the means of protection are incorporated into a sensor of the device.

According to an embodiment of the invention, the means of protection are formed by a cover of a case of the pressure measuring means.

According to a variation of the invention, the means of protection are incorporated into means of fixing the device or into any other supporting part of the device.

According to an embodiment of the invention, the means of protection have the form of a nail or a bar.

The present invention also relates to a sensor for measuring the pressure of a fluid containing iodized compounds and circulating in a pipe of a motor vehicle, comprising means of protection against iodine.

According to an embodiment of the invention, the means of protection are formed by a cover of the sensor's case.

This invention also relates to the use of the device or sensor according to the invention in order to measure the pressure of a fluid containing iodized compounds and circulating in a pipe of a motor vehicle.

Further aims, features and advantages of the invention will be better understood and emerge more clearly from the following description given with reference to the accompanying Figures, given by way of example, in which:

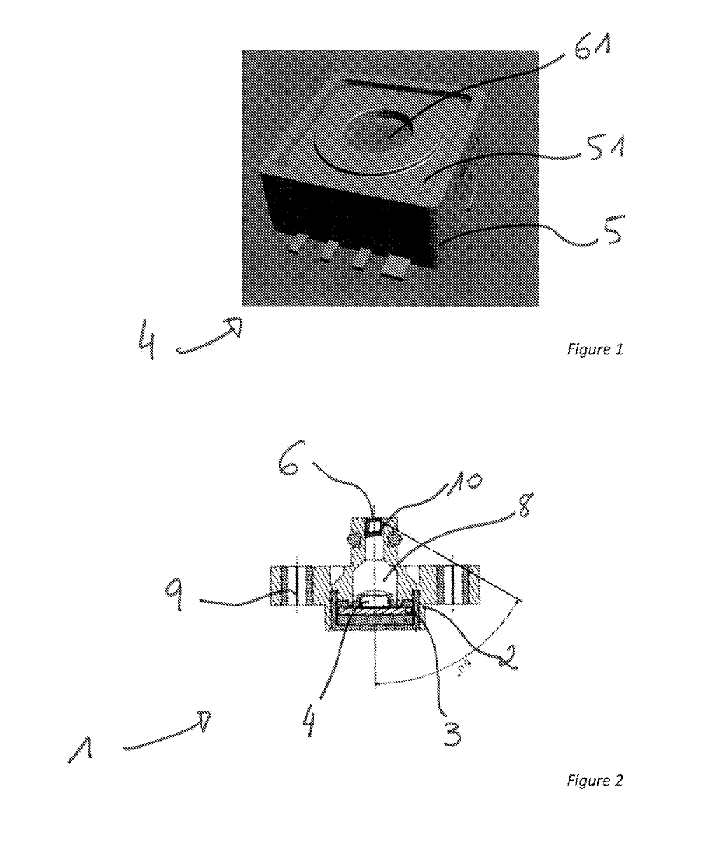

FIG. 1 is a schematic representation of a cross-section of a case of the device according to the invention,

FIG. 2 is a schematic representation of a perspective view of a part of a device according to the invention.

This invention relates to a device for measuring the pressure of a fluid.

According to a variation of the invention, the device measures the pressure and temperature of a fluid.

Within the scope of the invention and according to an embodiment, fluid means the air circulating in a pipe of an engine of a motor vehicle. More precisely, the fluid is the air circulating in the intake pipes. This fluid includes in its composition corrosive elements such as iodized compounds.

As shown in FIGS. 1 and 2, measuring device 1 according to the invention comprises a protective body 2 in which are arranged the means enabling the pressure of the fluid to be measured.

According to an embodiment of the invention, not shown, the body also contains means for measuring the temperature of the fluid.

According to an embodiment of the invention, the means enabling the pressure to be measured are formed in a conventional manner by a printed circuit 3, to which is connected a pressure sensor 4.

The sensor 4 is conventionally formed by a case 5 in which is arranged the sensor measuring cell and the wires connecting the sensor to connectors.

According to an embodiment of the invention, the cell is a silicon cell. This cell is glued to a ceramic substrate. The cell comprises on its surface aluminum wires. It is these wires in particular that can be damaged by the iodized compounds.

These sensor elements are covered by a gel. According to an embodiment of the invention the gel is a silicone gel.

The printed circuit and sensor assembly are protected by a resin. More precisely, this resin enables all of the electrical parts to be protected and to seal the product.

The case 5 comprises an opening 61 through which arrives the fluid whose pressure is to be measured.

The opening 61 is connected to an air intake pipe 6 of the device formed in the body 2 of the device.

According to an embodiment the device 1 thus comprises, when the air intake pipe 6 is located at the top of the device, an air intake pipe 6 in the device, then beneath this opening an empty space 8, then a layer of gel, then the means enabling the pressure to be measured.

According to an embodiment of the invention, the device comprises means 9 of fixing the body to the pipe in which circulates the fluid whose pressure is to be measured.

The body 2, or the fixing means 9, is connected to an electrical connector, not shown, enabling the measurement signals of the pressure sensor, and of the temperature sensor if present, to be transmitted to acquisition means connected to the electronic control unit of the internal combustion engine, in a conventional manner.

The device according to the invention comprises means 51, 10, of protecting against iodized compounds. More precisely, the protection means protect the electrical part of the sensor, and in particular the connection wires.

The means 51, 10 of protecting against iodized compounds are formed using a material enabling the corrosive effects of the iodized compounds to be countered by reacting with the iodine. The iodine reacting with this material is thus no longer available in the circulating air, and the pressure measuring elements are thus protected against corrosion by iodine.

According to an embodiment of the invention, the material is aluminum.

According to an embodiment of the invention, the material is made of or covered with zinc or tin or copper or silver or nickel.

According to a first variation of the invention, these means of protection are incorporated in the sensor. More precisely, these means are formed by a cover 51 of a case 5 of the pressure measuring means. This cover 51, which is conventionally made of plastic, is therefore within the scope of the invention made of aluminum or any other equivalent material as previously described. This cover 51 comprises an opening 61 enabling the fluid to pass through.

According to a second variation of the invention, the means of protection 10 are incorporated in the air intake pipe 6 of the device.

According to this second variation of the invention, the means of protection are formed by an additional element 10 added to the device. According to an embodiment of the invention of this second variation, this additional element is made so that its form matches that of the air intake pipe 6 of the body 2 and enables contact with the fluid, while allowing the fluid to reach the sensor. This element is for example in the form of a portion of tube or a plate. This additional element 10 is arranged at the air intake pipe 6 of the body 2. More precisely, this additional element 10 is arranged in the air intake pipe 6.

According to a third variation of the invention, the means of protection are incorporated into the fixing means 9 or into any other supporting part (not shown) of the device. According to this third variation, the means of protection have all types of forms enabling their incorporation, and for example the form of a nail, a bar, etc.

The scope of the present invention is not limited to the details given above and allows embodiments in numerous other specific forms without departing from the field of application of the invention. Consequently, these embodiments must be regarded as given by way of illustration and can be changed without, however, departing from the scope defined by the claims.

1. A device for measuring the pressure of a fluid, containing iodized compounds, comprising:
a body in which are arranged means enabling the pressure of the fluid to be measured; and
means for protecting against the iodized compounds.

2. The device according to claim 1, wherein the means of protection are made of aluminum.

3. The device according to claim 1, wherein the means of protection are made of or covered with zinc or tin or copper or silver or nickel.

4. The device according to claim 1, wherein the means of protection are incorporated into an air intake pipe of the device.

5. The device according to claim 4, wherein the means of protection are made so that their form matches the air intake pipe and allows contact with the fluid, while enabling the fluid to reach a sensor of the device.

6. The device according to claim 4, wherein the means of protection are formed by an additional element in the form of a portion of tube or a plate.

7. The device according to claim 1, wherein the means of protection are incorporated into a sensor of the device.

8. The device according to claim 7, wherein the means of protection are formed by a cover of a case of the sensor.

9. The device according to claim 1, wherein the means of protection are incorporated into means of fixing the device or into any other supporting part of the device.

10. The device according to claim, wherein the means of protection have the form of a nail or a bar.

11. A sensor for measuring the pressure of a fluid containing iodized compounds and circulating in a pipe of a motor vehicle, comprising means of protection against iodine.

12. The sensor according to claim 11, wherein the means of protection are formed by a cover of a case of the sensor.

13. A use of the device according to claim 1 to measure the pressure of a fluid containing iodized compounds and circulating in a pipe of a motor vehicle.

14. A use of the sensor according to claim 11 to measure the pressure of a fluid containing iodized compounds and circulating in a pipe of a motor vehicle.
